(19) United States
(12) Patent Application Publication
(10) Pub. No.: US 2017/0238230 A1
(43) Pub. Date: Aug. 17, 2017

(54) CONTROLLING VEHICLE TELEMATICS UNIT SELECTION OF RADIO ACCESS TECHNOLOGY

(71) Applicant: General Motors LLC, Detroit, MI (US)

(72) Inventor: Bonnie CHEN, Grapevine, TX (US)

(21) Appl. No.: 15/046,343

(22) Filed: Feb. 17, 2016

(51) Int. Cl. H04W 36/36; H04W 36/00; H04W 36/04

(52) U.S. Cl. CPC H04W 36/36; H04W 36/04; H04W 36/0011

(57) ABSTRACT

A system and method of controlling the Radio Access Technology selected by a vehicle telematics unit includes receiving a request to initiate a voice call from a vehicle occupant at the vehicle telematics unit; ending any existing data connection that is using a latest-technology RAT to communicate with a cell tower, wherein simultaneous voice and data (SVD) communications are not possible using the latest-technology RAT; ending the data connection with the cell tower using a latest-technology RAT; establishing the voice call via a cell tower using an older-technology RAT; detecting the end of the voice call; commanding the vehicle telematics unit to end use of the older-technology RAT in response; and establishing data communications with a cell tower via the latest-technology RAT.

### TECHNICAL FIELD

The present invention relates to cellular communications and, more particularly, to the selection of one Radio Access Technology (RAT) over another RAT.

### BACKGROUND

Vehicles are commonly equipped with vehicle telematics units that facilitate communications between the vehicle and central facilities providing telematics services to the vehicle. These telematics services can include vehicle diagnostic help, turn-by-turn navigational directions, assistance with emergencies, or other assistance provided by a central facility. The communications that accomplish these services are generally carried over wireless carrier systems that operate using one or more cellular protocols or Radio Access Technologies (RATs). Depending on the RAT chosen by the vehicle telematics unit, the amount of time it takes to deliver telematics service may vary considerably. But the vehicle telematics unit sometimes chooses a RAT not based on what is optimal for providing the fastest service but rather on one or more limitations that are unrelated to the speed of service. And once the vehicle telematics unit has chosen an older-technology RAT, it may be difficult for the vehicle telematics unit to stop using that RAT and reestablish communications using a latest-technology RAT.

### SUMMARY

According to an embodiment of the invention, there is provided a method of controlling the Radio Access Technology (RAT) selected by a vehicle telematics unit, that includes receiving a request to initiate a voice call from a vehicle occupant at the vehicle telematics unit; ending any existing data connection that is using a latest-technology RAT to communicate with a cell tower, wherein simultaneous voice and data (SVD) communications are not possible using the latest-technology RAT; ending the data connection with the cell tower using a latest-technology RAT; establishing the voice call via a cell tower using an older-technology RAT; detecting the end of the voice call; commanding the vehicle telematics unit to end use of the older-technology RAT in response; and establishing data communications with a cell tower via the latest-technology RAT.

According to another embodiment of the invention, there is provided a method of controlling the Radio Access Technology (RAT) selected by a vehicle telematics unit, that includes receiving a request for vehicle telematics services at the vehicle telematics unit from a vehicle occupant; initiating a voice call at the vehicle telematics unit in response to the request; ending use of a latest-technology RAT at the vehicle telematics unit in response to the request, wherein the latest-technology RAT does not support simultaneous voice and data (SVD); establishing a voice call to a central facility that provides telematics services using an older-technology RAT; detecting the end of the voice call; commanding the vehicle telematics unit to end use of the older-technology RAT in response; and communicating telematics service data between the vehicle telematics unit and the central facility using the latest-technology RAT.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of controlling vehicle telematics unit selection of a Radio Access Technology (RAT).

### DETAILED DESCRIPTION OF THE ILLUSTRATED EMBODIMENTS

The system and method described below controls vehicle telematics unit selection of a Radio Access Technology (RAT) in an environment where wireless carrier systems may not support RATs offering simultaneous voice and data (SVD). In these environments, the vehicle telematics unit may select from a plurality of RATs, some of which offer greater data communication speeds than others. When considering two or more RATs, a RAT offering greater data communication speeds relative to another RAT can be considered a latest-technology RAT while the slower RAT may be referred to as an older-technology RAT.

In some areas, the wireless carrier system may support data service via a latest-technology RAT that would normally support simultaneous SVD communications in same RAT but in spite of traditionally supporting SVD, the RAT may not support voice calls. For example, the wireless carrier system could offer only data service via a 4G LTE RAT but, for a number of reasons, may not support the voice communications functionality via the latest technology RAT (e.g., 4G LTE). Despite not offering SVD, the 4G LTE RAT may still be most desirable for communicating data because it offers the fastest data transfer speeds of all available RATs supported by the wireless carrier system despite not offering voice communications. So long as the vehicle's communications needs solely involve the communication of data, selecting the 4G LTE RAT may be optimal.

However, when a vehicle occupant places a voice call to a central facility to request telematics service, the vehicle telematics unit then may select a new, older-technology RAT necessitated by its support of voice communications. The newly-selected RAT may then offer slower data communications speeds than the latest-technology 4G LTE RAT but have the ability to support voice communications unlike the 4G LTE. In one example, the newly-selected RAT could be a 2G/GSM RAT that would be considered older-technology for data communications when compared to the 4G LTE RAT originally used by the vehicle telematics unit but offer the ability to establish a voice channel between the vehicle and the central facility.

When providing telematics service via the older-technology RAT, data transmissions communicated between the vehicle telematics unit and a central facility may be carried out using short message service (SMS) messages or using data sent over the voice channel that is supported by the older-technology RAT. Using the older-technology RAT, a vehicle occupant can initiate a call to a central facility with a request for telematics services and receive those services after ending the voice call. The telematics services can be in the form of turn-by-turn directions sent to the vehicle telematics unit or obtaining the vehicle's location from the vehicle telematics unit. Ideally, the vehicle telematics unit would detach itself from a cell tower using the older-technology RAT and then attach, or “camp on” a cell tower that offers the latest-technology RAT, such as LTE after the voice call ends. Unfortunately, ongoing communications at the vehicle telematics unit may conflict with instructions in the cellular chipset of the unit such that they prevent it from searching for and switching to a latest-technology RAT. And using data transmission mechanisms such as SMS or data over a voice channel can result in significant latencies when compared to data sent over the wireless carrier system using the latest technology (e.g., 4G LTE) RAT. This can result in an increase in the amount of time needed to provide data to a vehicle telematics unit after the vehicle occupant has ended voice communications with the central facility or a time failure to send data to vehicle telematics unit due to long amount of time for data delivery.

To avoid this increased amount of response time or failure to send data, the vehicle telematics unit can be programmed to command its cellular chipset to release or detach from the cell tower providing the older-technology RAT in response to the end of a voice call providing telematics service. The command to detach from the cell tower can initiate the vehicle telematics unit to begin a new search for cell towers and the RATs available in the currently available wireless carrier system. When a cell tower is available that supports the 4G LTE RAT, the vehicle telematics unit can select it and then communicate data as part of providing telematics service. The change from the older-technology RAT (e.g., 2G/GSM) to the latest-technology RAT (e.g., 4G LTE) can decrease the response time that exists between a request for telematics service and the delivery of such service.

### Communications System—

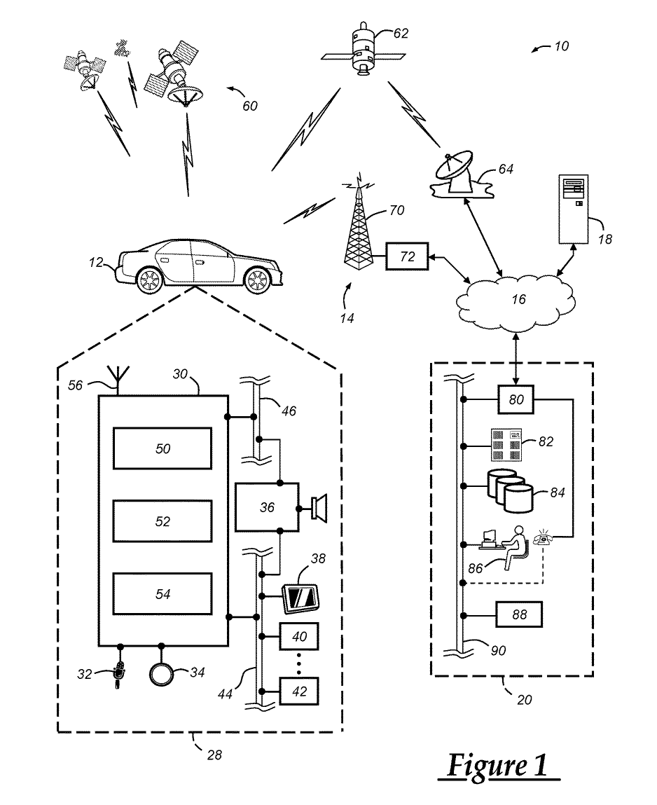

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network/public internet 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, LTE, or latest standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different RATs or protocols such as LTE, EVDO, CDMA, GPRS, and EDGE. As noted above, these examples of RATs can be classified as being a “latest-technology” RAT or an “older-technology” RAT. One way of distinguishing latest-technology RATs from older-technology RATs can be the relative data transfer speeds or bandwidth offered by the RAT; the faster data communication speed is associated with the latest-technology RAT. Another way of identifying a “latest-technology” RAT can include determining whether it is a cellular protocol that is normally capable of supporting SVD but only supports data communication without voice due to implementation difficulties at the wireless carrier system 14.

Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or dynamic IP address that is an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites.

From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70, one or more mobile switching centers (MSCs) 72, as well as any other networking components required to connect wireless carrier system 14 with land network/public internet 16. Each cell tower 70 includes sending and receiving antennas and a base station, with the base stations from different cell towers being connected to the MSC 72 either directly or via intermediary equipment such as a base station controller. Two different cell towers are shown in FIG. 1 each of which use a different RAT. Cell tower 70a may support a latest-technology RAT, such as 4G LTE, while cell tower 70b may support an older-technology RAT, such as 2G/GSM. While only two cell towers are shown, and those cell towers are described as using one RAT, other implementations are possible in which more than two cell towers are within communication range of the vehicle telematics unit 30 and/or the cell towers each support a plurality of different RATs. Cellular system 14 can implement any suitable communications technology, including for example, analog technologies such as AMPS, or the digital technologies such as CDMA (e.g., CDMA2000), GSM/GPRS, UMTS, or LTE. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

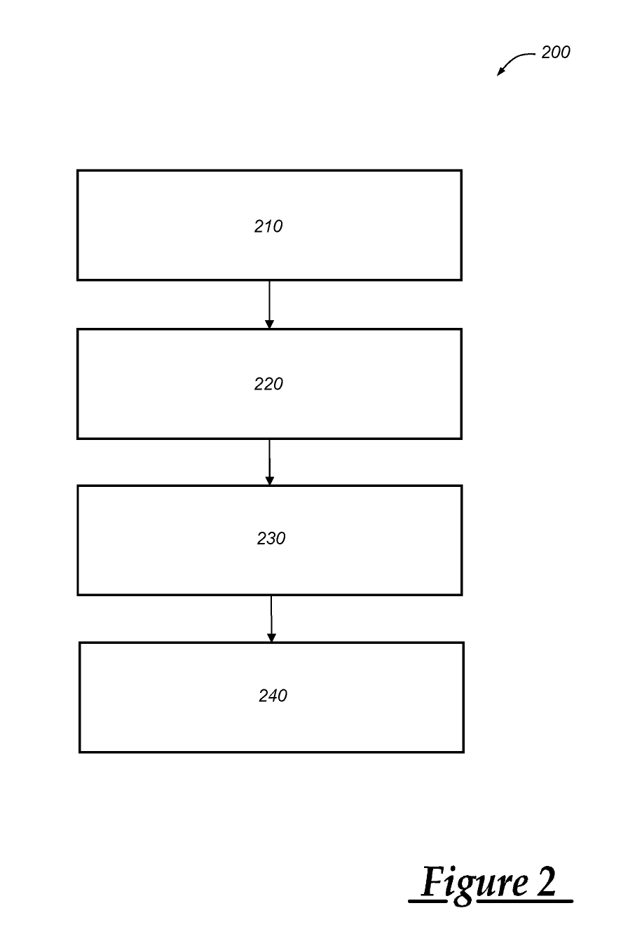

Turning now to FIG. 2, there is shown an implementation of a method (200) of controlling the Radio Access Technology (RAT) selected by the vehicle telematics unit 30. The method 200 begins by establishing a data connection at the vehicle telematics unit 30 with the cell tower 70a using a latest-technology RAT. In the environment in which the method 200 is performed, simultaneous voice and data (SVD) communications may not be possible using the latest-technology RAT. As a vehicle occupant or operator begins using the vehicle 12, the vehicle telematics unit 30 can wirelessly scan the area for nearby cell towers that are available for cellular communications. This scan can coincide with an ignition on event at the vehicle. When more than one cell tower and more than one RAT is available for communications via the wireless carrier system 14, the vehicle telematics unit 30 can select the RAT that offers the highest data communication speed. In one example, the vehicle telematics unit 30 can identify the two cell towers 70a and 70b that offer a latest-technology RAT and an older-technology RAT, respectively. For purposes of this example, the latest-technology RAT and an older-technology RAT will be described in terms of 4G LTE and 2G/GSM, respectively. After the ignition-on event, the vehicle telematics unit 30 can determine that only data is currently being transmitted between the vehicle telematics unit 30 and a central facility, such as the computer 18 or call center 20, and establish cellular communications for data transmissions with cell tower 70a. The vehicle telematics unit 30 can then send and receive data via the cell tower 70a using the data functionality of 4G LTE. The method 200 proceeds to step 220.

At step 220, a voice call is initiated at the vehicle telematics unit 30 in response to a request from a vehicle occupant. As part of providing telematics service to the vehicle 12, the vehicle telematics unit 30 permits vehicle occupants to initiate a call with the call center 20 to speak with the live advisor 86 who can provide a host of services, such as turn-by-turn directions, vehicle diagnostic information, vehicular infotainment, and concierge assistance. The live advisor 86 can verbally communicate with the vehicle occupant to receive spoken requests, initiate data uploads from the vehicle telematics unit 30, and, optionally, transmit data to the vehicle telematics unit 30 as part of providing a response. The data connection is ended with the cell tower 70a using a latest-technology RAT in response to the initiation of the voice call. The method 230 proceeds to step 230.

At step 230, the voice call is established via the cell tower 70b using an older-technology RAT. After ending the data connection with cell tower 70a, the vehicle telematics unit 30 can perform a wireless scan of the available cell towers and the RATs each cell tower supports. When SVD is not available, the vehicle telematics unit 30 can identify which of those RATs supports voice communications and then establish a voice channel with that cell tower. For instance, the vehicle telematics unit 30, after identifying the presence of the cell tower 70a using 4G LTE (without voice capability) and cell tower 70b using 2G/GSM, can establish a voice call with the call center 20 via the cell tower 70b using the older-technology 2G/GSM RAT. Using the delivery of turn-by-turn directions as one example of the telematics services the call center 20 can provide, the vehicle occupant can verbally ask the live advisor 86 for directions to a point-of-interest via the voice call. But given that the older-technology RAT does not support SVD, the vehicle occupant and live advisor 86 may conclude their verbal communications before the data needed for providing those services is obtained at the call center 20 and before telematics service, such as turn-by-turn direction, can be provided to the vehicle telematics unit 30. The method 200 proceeds to step 240.

At step 240, the vehicle telematics unit 30 detects the end of the voice call and commands the vehicle telematics unit 30 to end use of the older-technology RAT in response to detecting the voice call end and establish data communications using the cell tower 70a that supports the latest-technology RAT. To provide the turn-by-turn directions, the live advisor 86 may access the vehicle location of the vehicle 12 in the form of GPS coordinates generated by the GPS module 40 and then use that location to generate the turn-by-turn directions from the point-of-interest. The live advisor 86 can then wirelessly transmit the turn-by-turn directions as data to the vehicle telematics unit 30. Given that the older-technology RAT does not support SVD, the vehicle telematics unit 30 may transmit data representing vehicle location and turn-by-turn directions only after the voice call has ended. While the older-technology RAT can support the communication of data used to carry out telematics service, its data transfer times may result in longer wait times for receiving the telematics service than if the latest-technology RAT were used. In some environments, the vehicle location can be obtained by the call center 20 and turn-by-turn directions can be provided to the vehicle telematics unit 30 via the latest-technology RAT in less than 15 seconds whereas use of the older-technology RAT could result in wait times of 40 seconds or more. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of controlling a Radio Access Technology (RAT) selected by a vehicle telematics unit, comprising the steps of:
(a) receiving a request to initiate a voice call from a vehicle occupant at the vehicle telematics unit;
(b) ending any existing data connection that is using a latest-technology RAT to communicate with a cell tower in response to the request, wherein simultaneous voice and data (SVD) communications are not possible using the latest-technology RAT;
(c) establishing the voice call via a cell tower using an older-technology RAT;
(d) detecting the end of the voice call;
(e) commanding the vehicle telematics unit to end use of the older-technology RAT in response to step (d); and
(f) establishing data communications with a cell tower via the latest-technology RAT.

2. The method of claim 1, wherein the latest-technology RAT comprises a 4G LTE or beyond 4G cellular protocol.

3. The method of claim 1, wherein the older-technology RAT comprises a 2G/GSM or CDMA cellular protocol.

4. The method of claim 1, further comprising the step of establishing the data connection at the vehicle telematics unit with a cell tower using a latest-technology RAT prior to step (a).

5. The method of claim 4, wherein the data connection is established in response to an ignition on event at a vehicle.

6. A method of controlling a Radio Access Technology (RAT) selected by a vehicle telematics unit, comprising the steps of:
(a) receiving a request for vehicle telematics services at the vehicle telematics unit from a vehicle occupant;
(b) initiating a voice call at the vehicle telematics unit in response to the request;
(c) ending use of a latest-technology RAT at the vehicle telematics unit in response to the request, wherein the latest-technology RAT does not support simultaneous voice and data (SVD);
(d) establishing a voice call to a central facility that provides telematics services using an older-technology RAT;
(e) detecting the end of the voice call;
(f) in response to step (e), commanding the vehicle telematics unit to end use of the older-technology RAT; and
(g) communicating telematics service data between the vehicle telematics unit and the central facility using the latest-technology RAT.

7. The method of claim 6, wherein the latest-technology RAT comprises a 4G LTE or beyond 4G cellular protocol.

8. The method of claim 6, wherein the older-technology RAT comprises a 2G/GSM or CDMA cellular protocol.

9. The method of claim 6, further comprising the step of establishing a data connection at the vehicle telematics unit with a cell tower using the latest-technology RAT prior to step (a).

10. The method of claim 9, wherein the data connection is established in response to an ignition on event at a vehicle.
